(19) United States
(12) Patent Application Publication
(10) Pub. No.: US 2007/0245635 A1
(43) Pub. Date: Oct. 25, 2007

(54) Attachment structure of door weather strip for vehicle

(76) Inventors: Koso Deguchi, Hiroshima-ken (JP); Eiichi Baba, Hiroshima-ken (JP); Hiromu Oda, Hiroshima-ken (JP); Eiji Ono, Kanagawa (JP)

Correspondence Address: FLYNN THIEL BOUTELL & TANIS, P.C., 2026 RAMBLING ROAD, KALAMAZOO, MI, 49008-1631, US

(21) Appl. No.: 11/732,001

(22) Filed: Apr. 2, 2007

(30) Foreign Application Priority Data
Apr. 25, 2006 (JP) 2006-120102

(51) Int. Cl. E06B 7/22

(52) U.S. Cl. 49/498.1

(57) ABSTRACT

To provide an attachment structure of a weather strip for a vehicle capable of maintaining high-level sealing property even if the vehicle door is sucked outside during the run, while keeping excellent door-closing performance. The attachment structure comprises a base member to be attached to a retainer formed in a door sash, and a hollow seal portion integrally formed with the base member. The hollow seal portion is brought into contact with a body panel while the door is closed. A part of the body panel with which the hollow seal portion makes an elastic contact is configured as a parallel-sealing surface in parallel or roughly parallel to a sucked-out direction of the door during the run.

### BACKGROUND OF THE INVENTION

The present invention relates to a weather strip attached to a door sash of a vehicle, and having a hollow seal portion to be brought into contact with a body panel of the vehicle.

A prior art will be described hereinafter referring to FIGS. 6 to 8. Vehicle doors 1 are in general sucked toward outside the vehicle due to the pressure difference between the interior side and the exterior side of the vehicle, generated during the run. In order to prevent the sealing property of a weather strip 20 from being deteriorated due to so called “the sucked-out phenomenon”, a conventional weather strip 20 attached to the door sash 2 of a vehicle is provided with a hollow seal portion 21 whose elastic-deformation width D against the vertical-seal surface 25a formed roughly perpendicular to the door-closing direction C of the door 1 is set long enough. The “elastic-deformation width D” here refers to the length denoted with “D” in FIG. 7, which is the certain length of a part of the hollow seal portion 21 projecting from the virtual line showing the closed state of the body panel 25. Such construction is disclosed for example in the Japanese unexamined utility model publication No. H05-18930. The conventional structure is constructed so as to ensure high-level sealing property of the weather strip 20 even if the door 1 is sucked outside the vehicle.

However, this conventional prior art has such a problem that if the elastic-deformation width D of the hollow seal portion 21 is set longer than a required length, the so-called door-closing performance is deteriorated because the hollow seal portion 21 is loaded with a large reactive force when the door 1 is closed. On the other hand, if the elastic-deformation width D of the hollow seal portion 21 is set shorter in order to obtain the good door-closing performance, the sealing property of the weather strip 20 is deteriorated, because such condition decreases the contacting area and contacting force of the hollow seal portion 21 against the vertical-sealing surface 25, when the door 1 is sucked outside.

### SUMMARY OF THE INVENTION

The present invention is invented under such circumstances, and thus it is an object of the present invention to provide an attachment structure of a door weather strip for a vehicle, capable of ensuring high sealing property even if a door is sucked outside the vehicle during the run, while ensuring a good door-closing performance.

The present invention will be described hereinafter referring to FIGS. 1 to 3 and 6. An attachment structure of a door weather strip for a vehicle according to a first aspect of the invention comprises a door weather strip 10 having a base member 11 and a hollow seal portion 12. The base member 11 is configured to be attached to a retainer 2a of a door sash 2. The hollow seal portion 12 is integrally formed with the base member 11, and is configured to be brought into contact with a body panel 5, when a vehicle door 1 is closed.

The attachment structure further comprises a parallel-sealing surface 5a formed in a part of the body panel 5 with which the hollow seal portion 12 is brought into contact. The parallel-sealing surface 5a is formed parallel or roughly parallel to a sucked-out direction S of the door 1 during the run.

The attachment structure of a door weather strip for a vehicle according to a second aspect of the invention is such that in the first aspect of the invention, the base portion 2b of the retainer 2a further comprises a projection part 2c extendedly formed toward inside the vehicle. The hollow seal portion 12 of the weather strip 10 is configured in a triangular shape in section forming an outside-hypotenuse 12a therein. The outside-hypotenuse part 12a is to be brought into contact with the parallel-sealing surface 5a, while a part of the hollow seal portion 12 is brought into contact with the projection part 2c, at a time the door 1 is closed.

The attachment structure of a door weather strip for a vehicle according to a third aspect of the invention is such that in the first aspect of the invention, the parallel-sealing surface 5a is formed as long as it reaches to an outside-vertical surface 5b of the body panel 5. The weather strip 10 is provided with a seal lip 13 to be brought into elastic contact with an outside-corner of the parallel-sealing surface 5a.

The attachment structure of a door weather strip for a vehicle according to a fourth aspect of the invention is such that in the second aspect of the invention the parallel-sealing surface 5a is formed as long as it reaches to an outside-vertical surface 5b of the body panel 5. The weather strip 10 is provided with a seal lip 13 to be brought into elastic contact with an outside-corner of the parallel-sealing surface 5a.

The attachment structure of a door weather strip for a vehicle according to a fifth to eighth aspects of the invention is such that, in any of the first to the fourth aspects of the invention, the sucked-out direction (S) of the door 1 during the run is perpendicular to a door glass surface.

The attachment structure of a door weather strip for a vehicle according to a ninth to sixteenth aspects of the invention is such that, in any of the first to the eights aspects of the invention, the door-closing direction (C) is roughly horizontal, and a door glass surface is inclined toward the interior side of the vehicle.

The attachment structure of a weather strip for a vehicle according to the first aspect of the invention includes the parallel-sealing surface 5a in the body panel 5 in a direction parallel or roughly parallel to the sucked-out direction S of the vehicle door 1. The hollow seal portion 12 is brought into contact with the parallel-sealing surface 5a. Thus, when the vehicle door 1 is sucked outside during the run, moving together the weather strip 10 along the sucked-out direction S, the hollow seal portion 12 can still make a good elastic contact with the parallel-sealing surface 5a. This allows the attachment structure to maintain excellent sealing property.

The conventional prior art having the vertical-sealing surface 25a for sealing, defines the length of the elastic-deformation width D as to maintain sufficient sealing property even if the door 1 is sucked outside during the run. Thus, it provided the elastic-deformation width D longer than a required length needed for closing the door, which deteriorated the door-closing performance. As compared to this prior art, the attachment structure according to the present invention includes the hollow seal portion 12 to be brought into contact with the parallel-sealing surface 5a configured parallel or roughly parallel to the sucked-out direction S of the vehicle door 1, when the door 1 is closed. This makes it possible to construct the elastic-deformation width shorter than the prior art, thereby the door 1 in the present invention is loaded with less reaction force when closing the door 1. This allows the attachment structure of the present invention to improve the door-closing performance.

The attachment structure according to the second aspect of the invention makes it possible to maintain the high-level sealing property because the hollow seal portion 12 can still make a good elastic contact with the parallel-sealing surface 5a, even after the vehicle door 1 is sucked outside during the run, like the first aspect of the invention. This permits the attachment structure to carry out excellent door-closing performance.

Further, the attachment structure includes the hollow seal portion 12 configured into a triangular shape in section, and is constructed such that the outside-hypotenuse portion 12a of the hollow seal portion 12 is brought into elastic contact with the parallel-sealing surface 5a. Thus, this allows the attachment structure to construct the sealing width W with a longer length. That is, the hollow seal portion 12 configured in the triangular shape in section can form the bend section 12p at its vertex, and when the hollow seal portion 12 is brought into elastic contact with the parallel-sealing surface 5a at a time the door 1 is closed, the bend section 12p readily bends, thereby allowing almost entire surface of the outside-hypotenuse 12a to elastically contact with the parallel-sealing surface 5a. Thus, even if the vehicle door 1 is sucked outside during the run, the hollow seal portion 12 can still maintain the contacting status against the parallel-sealing surface 5a with the same sealing width W as before the door 1 is sucked outside. This allows the attachment structure to provide further high-level sealing performance. Further, since this attachment structure is constructed such that the hollow seal portion 12 elastically contacts with the projection part 2c, it enables for the hollow seal portion 12 to elastically contacts with the parallel-sealing surface 5a with much higher elastic force.

The attachment structure of a door weather strip for a vehicle according to the third and fourth aspects of the invention can perform the high-level sealing property and excellent door-closing performance, like the first and second aspects of the invention. Further, the attachment structure comprises the parallel-sealing surface 5a continuously extended to the outside-vertical surface 5b of the body panel 5. This allows the attachment structure to configure the shape of the body panel 5 simpler, to form the body panel 5 with less production steps, and to reduce the construction cost of the body panel 5, compared with, for example, a body panel having a bump structure in its outside.

Moreover, the door weather strip 10 comprises the seal lip 13 to be brought into contact with the outside-corner portion 5c of the body panel 5, which makes it possible to ensure more high-level sealing property with a combination of the hollow seal portion 12.

The first to the sixteenth aspects of the inventions as mentioned above provide further advantages as follows.

(A) The hollow seal portion 12 to be brought into contact with the parallel-sealing surface 5a allows the door 1 to be loaded with less reactive force when closing the door 1. This makes it possible not to reinforce the door sash 2 for further improvement in its strength, and it makes it possible to reduce the weight of the door 1 and the production cost thereof.

(B) The hollow seal portion 12 to be brought into contact with the parallel-sealing surface 5a will have the unchanged sealing width W against the parallel-sealing surface 5a at a time the door 1 is sucked outside, even after it is permanently deformed due to deterioration with age. This allows the attachment structure to maintain the high-level sealing property even in a sucked out position, for a long time of period.

In comparison with this, the conventional prior art is formed such that the sealing property is obtained by elastically contacting the hollow seal portion 12 with the vertical-sealing surface 25a, and by keeping sufficient elastic-deformation width D. This makes the conventional structure reduce the elastic contacting force against the vertical-sealing surface 25a, because, due to deterioration with age, the hollow seal portion 12 permanently deforms and it decreases the length of the elastic-deformation width D. As a result, the sealing property deteriorates while the door 1 is sucked outside.

(C) The attachment structure of the present invention, in which the hollow seal portion 12 is brought into contact with the parallel-sealing surface 5a, can permit the door 1 to be loaded with less reactive force, unlike the conventional prior art which is loaded with high reactive force due to a construction having the long elastic-deformation width D. Thus, the door sash 2 according to the invention does not move from the fixed position caused by the reactive force, and it can maintain the excellent outer appearance.

(D) In the attachment structure comprising the hollow seal portion 12 to be brought into elastic contact with the parallel-sealing surface 5a, the distance between the base portion 2b of the retainer 2a and the parallel-sealing surface 5a (the distance along the align line perpendicular to both the parallel-sealing surface 5a and the base portion 2b) at a time the door 1 is sucked outside is the same as that the door 1 is not sucked out. This makes it possible to provide a high-level noise insulating property in the high-speed run, as well. In comparison with this, the noise insulating property deteriorated is the conventional prior art comprising the hollow seal portion 12 to be brought into elastic contact with the vertical-sealing surface 25a. It is because the distance between the base portion 2b of the retainer and the vertical-sealing surface 25a widens at a time the door 1 is sucked outside.

### BRIEF DESCRIPTION OF THE DRAWINGS

FIG. 1 is a sectional view along line X-X in FIG. 6, showing an embodiment of the attachment structure according to the present invention;

FIG. 2 is a sectional view (in a fixed and not sucked-out position) showing a state in which the hollow seal portion and the parallel-sealing surface illustrated in FIG. 1 are elastically contacting with each other;

FIG. 3 is a sectional view (in a sucked-out position) showing a state in which the hollow seal portion and the parallel-sealing surface illustrated in FIG. 1 are elastically contacting with each other;

FIG. 4 shows a graph showing a comparison of the compressive load value between the present invention and a prior art obtained by compressing them toward the door-closing direction;

FIG. 5 is a graph showing the compression load value of the present invention and a prior art obtained by moving them toward the sucked-out direction;

FIG. 6 is a side elevation view showing a vehicle having an attachment structure of a door weather strip;

FIG. 7 is a cross sectional view along line X-X in FIG. 1, showing an attachment structure according to a conventional prior art;

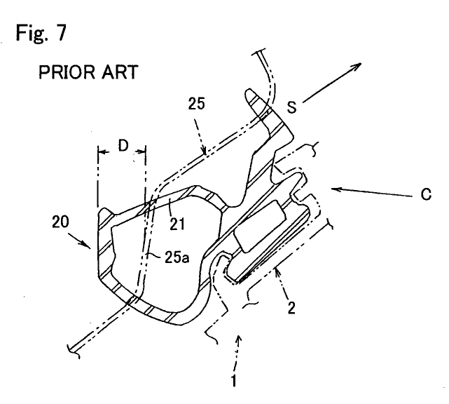

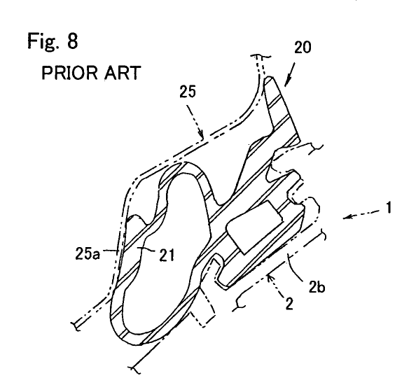

and, FIG. 8 is a sectional view showing a state in which the hollow seal portion and the parallel-sealing surface illustrated in FIG. 7 are elastically contacting with each other.

### PREFERRED EMBODIMENT OF THE INVENTION

The term of “the sucked-out direction S” will be described first. While a vehicle is running, the external air pressure of the vehicle decreases compared to the internal air pressure over a door glass, due to the fact that as the speed of air flowing from the front side to the rear side along the side surfaces of the vehicle increases, the air pressure there decreases. A vehicle door is fixed to a vehicle body with hinges disposed at the upper side and lower side of a metal panel forming a lower half of the door. On the other hand, an upper half of the door is composed mainly of a door glass, and the periphery of the door glass is not provided with hinges. In addition, generally, vehicles have such doors whose upper halves (door glass portions) are inclined toward the interior side of the vehicle. Thus, during the run with a door glass completely closed, an external force is so activated that the virtual horizontal line connecting between the upper side of the hinge and a door lock is directed perpendicular to the door glass surface, which is the direction directed to the outer-upper oblique direction from the door glass surface. This direction of the outer force is the sucked-out direction S.

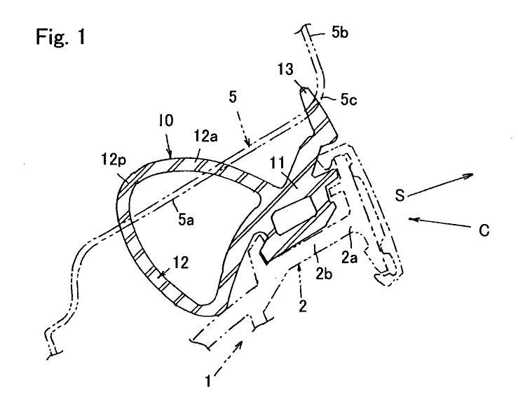

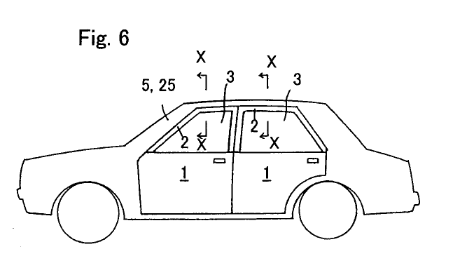

A preferred embodiment of an attachment structure of a door weather strip for a vehicle according to the present invention will be described referring to FIGS. 1 to 3 and 6. The attachment structure is attached to a vehicle including a door 1 having the sucked-out direction S forwarding in the upper oblique direction during the run, and the door-closing direction C adjusted roughly horizontal. The attachment structure comprises a door weather strip 10 having a base member 11 and a hollow seal portion 12. The base member 11 is attached to a retainer 2a formed in a door sash 2. The hollow seal portion 12 is integrally formed with the base member 11, and is brought into contact with a body panel 5 when the door 1 is closed. The attachment structure comprises a parallel-sealing surface 5a selectively formed in a flat shape in the particular area of the body panel where the hollow seal portion 12 is brought into contact with. The parallel-sealing surface 5a is formed in a direction highly parallel to the sucked-out direction S of the door 1. The base portion 2b formed in the retainer 2a in this attachment structure is configured roughly parallel to the parallel-sealing surface 5a and the sucked-out direction S of the door 1. Further, the hollow seal portion 12 is also brought into elastic contact with a projection part 2c of the retainer 2a, which is extendedly formed toward the interior side of the vehicle from the retainer 2a.

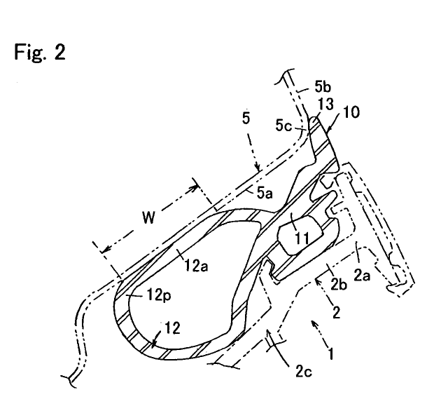

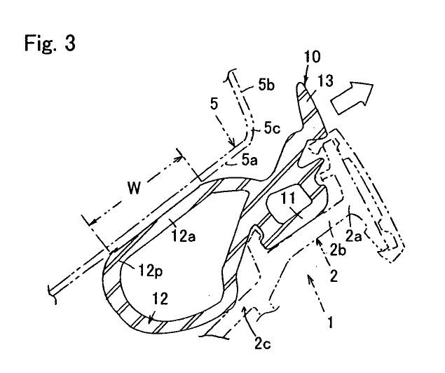

In the attachment structure with such construction, the hollow seal portion 12 can still make an elastic contact with the parallel-sealing surface 5a and the projection part 2c, even if the door 1 is sucked outside making the weather strip 10 moving along the sucked-out direction S. In this sucked out condition, the length of the sealing width W is still the same as that of in the non-sucked out condition (See FIGS. 2 and 3.). This makes it possible for the attachment structure to carry out high-level sealing property.

Further, the hollow seal portion 12 is brought into elastic contact with the parallel-sealing surface 5a configured highly parallel to the sucked-out direction S of the door 1. This allows the door 1 to be loaded with less reactive force when the door 1 is closed, compared to the conventional prior art, thereby providing excellent door-closing performance.

Moreover, the door 1 configured to be loaded with less reactive force makes it possible not to reinforce the door sash 2 to improve its strength, and to construct the structure lighter in weight and less expensive.

Further, the attachment structure of this embodiment comprises the hollow seal portion 12 being configured in a triangular shape in section, and about an entire portion of the outer surface of the outside-hypotenuse portion 12a is to be brought into elastic contact with the parallel-sealing surface 5a. Such construction makes it possible to form the bending portion 12p at the vertex of the hollow seal portion 12. This bending portion 12p easily bends when the hollow seal portion 12 is brought into contact with the parallel-sealing surface 5a after the door 1 is closed. This enables the hollow seal portion 12 to elastically contact with the parallel-sealing surface 5a at its almost entire portion of the outer surface of the outside-hypotenuse portion 12a. This allows the hollow seal portion 12 to elastically contact with the parallel-sealing surface 5a with a wider area thereof, even when the door 1 is sucked outside during the run, thereby providing high-level sealing property.

Further, the attachment structure according to this embodiment comprises the parallel-sealing surface 5a extendedly formed in a flat shape until it reaches to the outside vertical surface 5b. This makes it possible to simplify the shape of the body panel 5, to improve formability, and to reduce production cost.

Moreover, the door weather strip 10 includes the seal lip 13 to be brought into contact with the outside corner portion of the parallel-sealing surface 5a. This allows the door weather strip 10 to conduct sealing function with both the hollow seal portion 12 and the seal lip 13, thereby further improving the sealing performance of the attachment structure.

Further, the attachment structure in which the hollow seal portion 12 is brought into contact with the parallel-sealing surface 5a permits the door 1 to be loaded with less reactive force when closing the door 1. Thus, it is unneeded to reinforce the door 1 to improve its strength, which provides an advantage in reducing the weight of the door 1 and the production cost thereof.

Further, the length of the sealing width W to be brought into contact with the parallel-sealing surface 5a does not change even if the hollow seal portion 12 permanently deforms due to deterioration with age, in a condition of a long-time contact between the hollow seal portion 12 and the parallel-sealing surface 5a. This allows the attachment structure to provide an advantage that it can keep high-level sealing property for a long time.

Moreover, the attachment structure having the hollow seal portion 12 to be brought into contact with the parallel-sealing surface 5a allows the door 1 to be loaded with less reactive force, and thus it inhibits the door sash 2 to move from the fixed position. Thus, the attachment structure is excellent in its outlook appearance.

### EXAMPLES

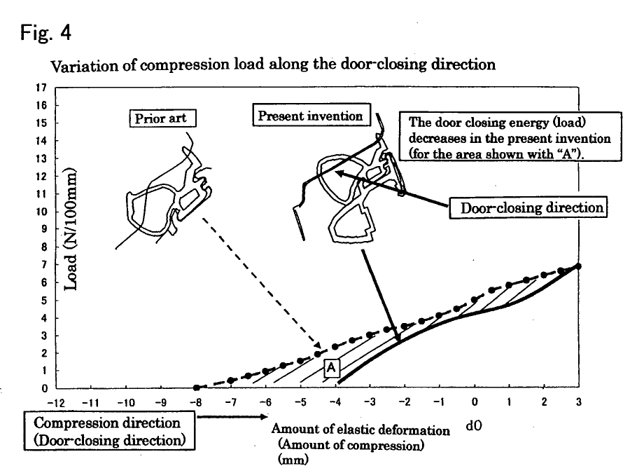

FIG. 4 is a graph showing an experimental test result demonstrating a relation between the elastic deformation width and compression load in relative to the present invention and a conventional prior art. This test was completed using pieces of weather strips with a length of 100 mm prepared for this test. The weather strip shown in the upper right represents the present invention, and the one shown in the upper left represents the prior art, both in cross section. In this graph, the horizontal axis indicates the elastic-deformation quantity (mm), and the vertical axis the compression load (N/mm). The pieces of the weather strips were closed with a speed of 20 mm/minute. The reference number “dO” under 0 in the graph indicates the compression load measured when the door is disposed in the stipulated position. As this graph clearly demonstrates, the compression load applied to the weather strip representing the present invention is much less than the weather strip of the prior art, which is indicated by the area shown with the dotted zone and with the reference number “A”.

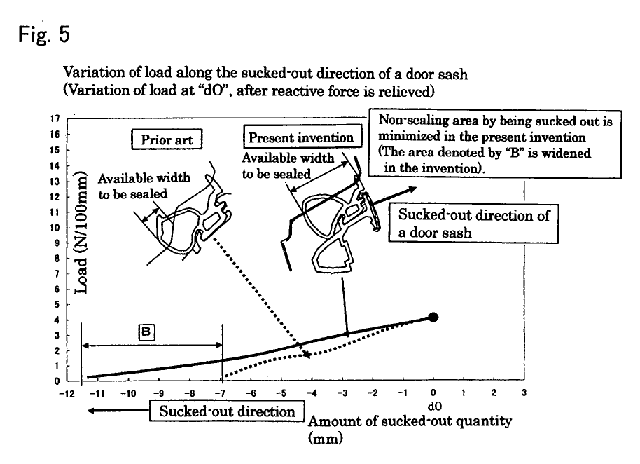

FIG. 5 is a graph of a test result showing a relation between the sucked out amount of and the compression load loaded to the weather strip of the present invention and that of the conventional prior art. The reference number “dO” under 0 in the graph indicates the stipulated closed position of the weather strips. The weather strip illustrated in the upper right of the graph represents the present invention, and the one in the upper left represents the prior art. As it is clear from this graph, the weather strip representing the present invention is loaded with the compression load in a wider area along the horizontal axis, which indicates the sucked out amount. This demonstrates that the present invention can keep the sealing status even it is sucked outside further than the prior art. Although not clearly shown in this graph, it should be noted that the weather strip of the present invention was able to have the sealing width of 2.7 mm against the parallel-sealing surface after being sucked out 12 mm.

It should also be noted that the weather strip according to the present invention requires the elastic-deformation width D of only 4 to 6 mm, whereas that of the conventional prior art requires 7 to 8 mm, to allow the weather strips to perform sufficient sealing property.

What is claimed is:

1. An attachment structure of a door weather strip for a vehicle comprising a door weather strip having a base member and a hollow seal portion, said base member being configured to be attached to a retainer of a door sash, said hollow seal portion being integrally formed with said base member and being configured to be brought into contact with a body panel when a vehicle door is closed wherein,
said attachment structure further comprising a parallel-sealing surface formed in a part of said body panel with which said hollow seal portion is brought into contact, said parallel-sealing surface being formed parallel or roughly parallel to a sucked-out direction of the door during the run.

2. The attachment structure of a door weather strip for a vehicle claimed in claim 1, wherein the base portion of the retainer further comprises a projection part extendedly formed toward inside the vehicle, and the hollow seal portion of the weather strip is configured in a triangular shape in section forming an outside-hypotenuse therein, wherein,
said outside-hypotenuse part is to be brought into contact with the parallel-sealing surface, while a part of the hollow seal portion is brought into contact with the projection part, at a time the door is closed.

3. The attachment structure of a door weather strip for a vehicle claimed in claim 1, wherein the parallel-sealing surface is formed as long as it reaches to an outside-vertical surface of the body panel, and the weather strip is provided with a seal lip to be brought into elastic contact with an outside-corner of the parallel-sealing surface.

4. The attachment structure of a door weather strip for a vehicle claimed in claim 2, wherein the parallel-sealing surface is formed as long as it reaches to an outside-vertical surface of the body panel, and the weather strip is provided with a seal lip to be brought into elastic contact with an outside-corner of the parallel-sealing surface.

5. The attachment structure of a door weather strip for a vehicle claimed in claim 1, wherein the sucked-out direction of the door during the run is perpendicular to a door glass surface.

6. The attachment structure of a door weather strip for a vehicle claimed in claim 2, wherein the sucked-out direction of the door during the run is perpendicular to a door glass surface.

7. The attachment structure of a door weather strip for a vehicle claimed in claim 3, wherein the sucked-out direction of the door during the run is perpendicular to a door glass surface.

8. The attachment structure of a door weather strip for a vehicle claimed in claim 4, wherein the sucked-out direction of the door during the run is perpendicular to a door glass surface.

9. The attachment structure of a door weather strip for a vehicle claimed in claim 1, wherein the door-closing direction is roughly horizontal, and a door glass surface is inclined toward the interior side of the vehicle.

10. The attachment structure of a door weather strip for a vehicle claimed in claim 2, wherein the door-closing direction is roughly horizontal, and a door glass surface is inclined toward the interior side of the vehicle.

11. The attachment structure of a door weather strip for a vehicle claimed in claim 3, wherein the door-closing direction is roughly horizontal, and a door glass surface is inclined toward the interior side of the vehicle.

12. The attachment structure of a door weather strip for a vehicle claimed in claim 4, wherein the door-closing direction is roughly horizontal, and a door glass surface is inclined toward the interior side of the vehicle.

13. The attachment structure of a door weather strip for a vehicle claimed in claim 5, wherein the door-closing direction is roughly horizontal, and a door glass surface is inclined toward the interior side of the vehicle.

14. The attachment structure of a door weather strip for a vehicle claimed in claim 6, wherein the door-closing direction is roughly horizontal, and a door glass surface is inclined toward the interior side of the vehicle.

15. The attachment structure of a door weather strip for a vehicle claimed in claim 7, wherein the door-closing direction is roughly horizontal, and a door glass surface is inclined toward the interior side of the vehicle.

16. The attachment structure of a door weather strip for a vehicle claimed in claim 8, wherein the door-closing direction is roughly horizontal, and a door glass surface is inclined toward the interior side of the vehicle.
